(19) United States
(12) Patent Application Publication
(10) Pub. No.: US 2025/0251193 A1
(43) Pub. Date: Aug. 7, 2025

(54) GRANULATE DRYING SYSTEMS WITH MOISTURE-SENSING CAPABILITIES

(71) Applicant: Novatec, Inc., Baltimore, MD (US)

(72) Inventors: Conrad BESSEMER, Millersville, MD (US); Mark HAYNIE, Pasadena, MD (US); Gregory Michael WASHBURN, Bridgeville, MD (US); Frederick W. EICHHORN, II, Finksburg, MD (US); Diego Ruben BARRETTINO, Lugano (CH)

(73) Assignee: Novatec, Inc., Baltimore, MD (US)

(21) Appl. No.: 18/432,821

(22) Filed: Feb. 5, 2024

(51) Int. Cl. F26B 25/22; F26B 3/04; F26B 21/08; F26B 21/10; F26B 21/12

(52) U.S. Cl. CPC F26B 25/22; F26B 3/04; F26B 21/08; F26B 21/10; F26B 21/12; F26B 2200/08

(57) ABSTRACT

Drying hoppers for drying granular materials can be equipped with a sensor array that sensors parameters within the drying hopper indicative of the moisture content of the granular material, allowing the drying process to be adjusted as necessary to help ensure that the granulate material is properly dried upon leaving the drying hopper.

### BACKGROUND

Hygroscopic materials in granular form often contain moisture that needs to be removed from the material before the material is processed. For example, resin granulates used in the manufacture of plastic products typically are subjected to a drying process to remove moisture that may be present in the resin granulates. Such moisture, if present during the molding process, can result in surface defects, bubbles, structural deficiencies, lack of color homogeneity, etc., in the final product.

The drying process typically is performed by loading the plastic resin granulates into an interior volume of a drying hopper, and introducing dry, warm process air into the interior volume. The process air absorbs moisture from the resin granulates as the process air passes over the resin granulates. Prior to drying, the resin granulates may be held in a storage vessel such as a Gaylord box, a silo, a railcar, etc. The resin granulates may be transferred directly to the drying hopper from the storage vessel by a vacuum system. Alternatively, the resin granulates may be transferred to a receiver that holds the resin granulates, and feeds the resin granulates to the drying hopper in a controlled manner.

The manufacturers of resin granulates typically provide a recommended duration (residence time), defined as the value of the interior volume 20 of the drying hopper 12 divided by the required volumetric production rate of the drying hopper 12; the process-air temperature; and the final granulate moisture content for the drying process, i.e., manufacturers typically provide a drying time and drying-air temperature that should result in an acceptable moisture level in the resin granulates at the end of the drying process. The recommended values for duration and process-air temperature are conservative, to help ensure that the resin granulates are dried to the recommended final moisture level regardless of the moisture level in the granulates at the start of the drying process, i.e., the drying time and temperature are chosen so that resin granulates having an initial moisture level at or near the maximum acceptable value will leave the drying hopper with a moisture level acceptable for the subsequent processing operation. Thus, resin granulates having an initial moisture level below the maximum acceptable value may be dried for a longer period of time, and/or at a higher temperature than is necessary to dry the granulates sufficiently. In such cases, the throughput and/or energy usage of the dryer are less than optimal, leading to higher energy costs than necessary and/or lower production rates than otherwise could be achieved. Also, resin granulates with a relatively low initial moisture level may be over-dried, which can result in deficiencies in the products manufactured from the granulates, and in some cases may necessitate discarding the resin granulates.

It is known to measure the moisture content of the resin granulates as the resin granulates exit the drying hopper. Although such measurements can provide an indication of whether the resin granulates have been dried properly, in the event the resin granulates exiting the drying hopper are under-dried or over-dried, it is too late at that point to correct or adjust the drying process because the drying process for those resin granulates has been completed. Thus, any corrective action to the drying process can be applied on a retrospective basis only.

It is also known to measure the moisture content of the resin granulates upstream of the interior volume of drying hopper. Such measurements can facilitate adjustment of the operating parameters of drying hopper to account for resin granulates having a moisture content above or below the levels upon which the manufacturer's recommend drying time is based. These upstream measurements, however, do not account for the actual drying rate that occurs within the drying hopper. The actual drying rate is a function of the geometry of the drying hopper; the flow-rate, dew point, and temperature of the process air; the quantity and condition of the desiccant used to dry the process air; the shape of the resin granulates being dried; the percent of regrind in the resin; and the air distribution and resin-granulate distribution, or mass flow, within the drying hopper. Since the actual drying rate can vary from the expected or targeted drying rate due to variations in these factors, measuring the granulate moisture content upstream of the drying hopper cannot ensure that the resin granulates exiting the drying hopper have been dried properly.

### SUMMARY

In one aspect of the disclosed technology, a process for drying a granular material includes providing a drying hopper configured to direct air over the granular material while the granular material resides within an interior volume of the drying hopper, determining an actual moisture content of the granular material within the interior volume, and altering one or more parameters of the drying process based on the actual moisture content of the granular material within the interior volume.

In another aspect of the disclosed technology, altering one or more parameters of the drying process based on the actual moisture content of the granular material within the interior volume of the drying hopper includes altering a property of the air.

In another aspect of the disclosed technology, altering a property of the air includes altering a temperature, a volumetric flow rate, and/or a dew point of the air based on the actual moisture content of the granular material within the interior volume.

In another aspect of the disclosed technology, altering one or more parameters of the drying process based on the actual moisture content of the granular material within the interior volume includes altering a residence time of the granular material within the interior volume.

In another aspect of the disclosed technology, determining an actual moisture content of the granular material within the interior volume of the drying hopper includes determining an actual moisture content of the granular material at a plurality of vertical locations within the interior volume.

In another aspect of the disclosed technology, the process further includes providing a sensor array having at least one sensor configured to provide information relating to the actual moisture content of the granular material within the interior volume. Determining an actual moisture content of the granular material within the interior volume includes determining the actual moisture content of the granular material within the interior volume based on the information relating to the actual moisture content of the granular material within the interior volume.

In another aspect of the disclosed technology, providing a sensor array having at least one sensor configured to provide information relating to the actual moisture content of the granular material within the interior volume includes providing at least one temperature sensor configured to measure a temperature of the granular material, and providing at least one dew-point sensor configured to measure a dew point of the air within interior volume.

In another aspect of the disclosed technology, providing at least one temperature sensor configured to measure a temperature of the granular material includes providing a plurality of the temperature sensors configured to measure the temperature of the granular material at a plurality of vertical positions within the interior volume. Providing at least one dew-point sensor configured to measure a dew point of the air with interior volume includes providing a plurality of the dew-point sensors configured to measure the dew-point of the air within the interior volume at a plurality of vertical positions within the interior volume.

In another aspect of the disclosed technology, the process further includes immersing at least a portion of the sensor array in the granular material within the interior volume.

In another aspect of the disclosed technology, providing at least one sensor configured to provide information relating to the actual moisture content of the granular material within the interior volume includes providing at least one moisture sensor configured to directly measure the actual moisture content of the granular material.

In another aspect of the disclosed technology, providing at least one moisture sensor configured to directly measure the actual moisture content of the granular includes providing a plurality of the moisture sensors configured to directly measure the actual moisture content of the granular material at a plurality of vertical positions within the interior volume.

In another aspect of the disclosed technology, the process further includes immersing at least a portion of the sensor array in the granular material within the interior volume.

In another aspect of the disclosed technology, altering a parameter of the drying process based on the actual moisture content of the granular material within the interior volume of the drying hopper incudes altering the parameter of the drying process based on a difference between the actual moisture content of the granular material within the interior volume and a targeted moisture content of the granular material.

In another aspect of the disclosed technology, determining an actual moisture content of the granular material within the interior volume of the drying hopper includes determining an actual moisture content of the granular material at a plurality of vertical locations within the interior volume, and altering a parameter of the drying process based on a difference between the actual moisture content of the granular material within the interior volume and a targeted moisture content of the granular material includes altering the parameter of the drying process based on a difference between a vertical profile of the actual moisture content of the granular material within the interior volume and a vertical profile the targeted moisture content of the granular material.

In another aspect of the disclosed technology, a system for drying a granular material includes a drying hopper defining an interior volume configured to hold the granular material, an air inlet configured to facilitate the passage of air into the interior volume, an entrance opening configured to facilitate entry of the granulate material into the interior volume, and an exit opening configured to facilitate exit of the granulate material from the interior volume. The system also includes a sensor array having one or more sensors configured to sense at least one parameter within the interior volume indicative of a moisture content of the granular material within the interior volume, and a controller communicatively coupled to the one or more sensors and configured to determine the moisture content of the granular material within the interior volume based on the at least one parameter within the interior volume indicative of a moisture content of the granular material within the interior volume.

In another aspect of the disclosed technology, the at least one parameter within the interior volume indicative of a moisture content of the granular material within the interior volume is a temperature of the granular material and a dew-point of the air within the interior volume.

In another aspect of the disclosed technology, the at least one parameter within the interior volume indicative of a moisture content of the granular material within the interior volume is an actual moisture of the granular material.

In another aspect of the disclosed technology, the sensor array includes a probe configured to be immersed in the granular material. The probe includes a body, and the one or more sensors housed within the body.

In another aspect of the disclosed technology, the sensor array includes a plurality of the sensors, and the one or more sensors are positioned at a plurality of vertical locations within the interior volume.

In another aspect of the disclosed technology, at least one of the one or more sensors includes a temperature sensor configured to measure a temperature of the granular material, and at least one of the sensors includes a dew point sensor configured to measure a dew-point of the air with interior volume.

In another aspect of the disclosed technology, at least one of the one or more sensors includes a moisture sensor configured to directly measure the moisture content of the granular material.

In another aspect of the disclosed technology, the controller is further configured to regulate at least one operating parameter of the drying hopper based on the at least one parameter within the interior volume.

In another aspect of the disclosed technology, the controller is further configured to regulate at least one of a volumetric flow rate of the air, a temperature of the air, and a dew point of the air based on the at least on parameter sensed within the interior volume.

In another aspect of the disclosed technology, the controller is further configured to compare the actual moisture content of the granular material within the interior volume to a targeted value for the moisture content of the granular material within the interior volume, and to regulate the at least one operating parameter based on the comparison of the actual moisture content of the granular material within the interior volume to the targeted value for the moisture content of the granular material within the interior volume.

In another aspect of the disclosed technology, the sensor array includes a plurality of the sensors configured to sense the at least one parameter within the interior volume. The plurality of sensors are positioned at a plurality of vertical locations within the interior volume. The controller is further configured to regulate the at least one operating parameter based on a difference between a vertical profile of the actual moisture content of the granular material within the interior volume and a vertical profile the targeted moisture content of the granular material within the interior volume.

In another aspect of the disclosed technology, the sensor array further includes a housing configured to be mounted at least in part outside of the drying hopper. The one or more sensors being disposed within the housing. The sensor array further includes one or more conduits in fluid communication with the one or more sensors and the interior volume of the drying hopper.

In another aspect of the disclosed technology, a sensor array is configured for use with a drying hopper for drying a granular material. The hopper defines an interior volume configured to hold the granulate material, an air inlet configured to facilitate the passage of air into the interior volume, an entrance opening configured to facilitate entry of the granulate material into the interior volume; and an exit opening configured to facilitate exit of the granular material from the interior volume.

The sensor array includes one or more sensors configured to sense at least one parameter within the interior volume of the drying hopper indicative of a moisture content of the granular material within the interior volume.

In another aspect of the disclosed technology, the sensor array further includes a probe configured to be immersed in the granular material and including a body, and the one or more sensors housed within the body.

In another aspect of the disclosed technology, the one or more sensors include a plurality of the sensors, and the probe is further configured so that the plurality of sensors are positioned at a plurality of vertical locations within the interior the volume when the probe is installed on the drying hopper.

In another aspect of the disclosed technology, the sensor array further includes a housing configured to be mounted at least in part outside of the drying hopper, and the one or more sensors are disposed within the housing. The sensor array further includes one or more conduits configured to communicate fluidly with the one or more sensors and the interior volume of the drying hopper.

In another aspect of the disclosed technology, the one or more sensors include a plurality of the sensors, the one or more conduits include a plurality of the conduits, and the conduits are configured so that respective entrances of the conduits are positioned at a plurality of vertical locations within the interior the volume when the sensor array is installed on the drying hopper.

In another aspect of the disclosed technology, the one or more sensors include a temperature sensor configured to measure a temperature of the granular material, and a dew point sensor configured to measure a dew point of the air with interior volume.

In another aspect of the disclosed technology, the one or more sensors include a moisture sensor configured to directly measure a temperature of the granular material.

In another aspect of the disclosed technology, the sensor array further includes a controller communicatively coupled to the one or more sensors. The one or more sensors are further configured to generate an output that, when received by the controller, causes the controller to determine the moisture content of the granular material within the interior volume based on the output.

In another aspect of the disclosed technology, the controller is further configured to regulate an operating parameter of the drying hopper based on the moisture content of the granular material within the interior volume.

In another aspect of the disclosed technology, the controller is further configured to compare the moisture content of the granular material within the interior volume to a targeted value for the moisture content of the granular material within the interior volume, and to regulate the at least one operating parameter based on the comparison of the moisture content of the granular material to the targeted value for the moisture content of the granular material.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a diagrammatic, cutaway view of a drying system for granular materials;

FIG. 2 is a side view of a measurement probe of the system shown in FIG. 1;

FIG. 3 is a side view of the measurement probe shown in FIG. 2, taken from a perspective rotated 90 degrees from the perspective of FIG. 2;

FIG. 4 is a bottom view of the measurement probe shown in FIGS. 2 and 3;

FIG. 5 is a magnified cross-sectional view of the area designated “A” in FIG. 3;

FIG. 6 is a diagrammatic illustration of electrical and electronic components of the system shown in FIG. 1; and

FIG. 7 is a diagrammatic, cutaway view of an alternative embodiment of the drying system shown in FIG. 1.

### DETAILED DESCRIPTION

The inventive concepts are described with reference to the attached figures, wherein like reference numerals represent like parts and assemblies throughout the several views. The figures are not drawn to scale and are provided merely to illustrate the instant inventive concepts. The figures do not limit the scope of the present disclosure or the appended claims. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

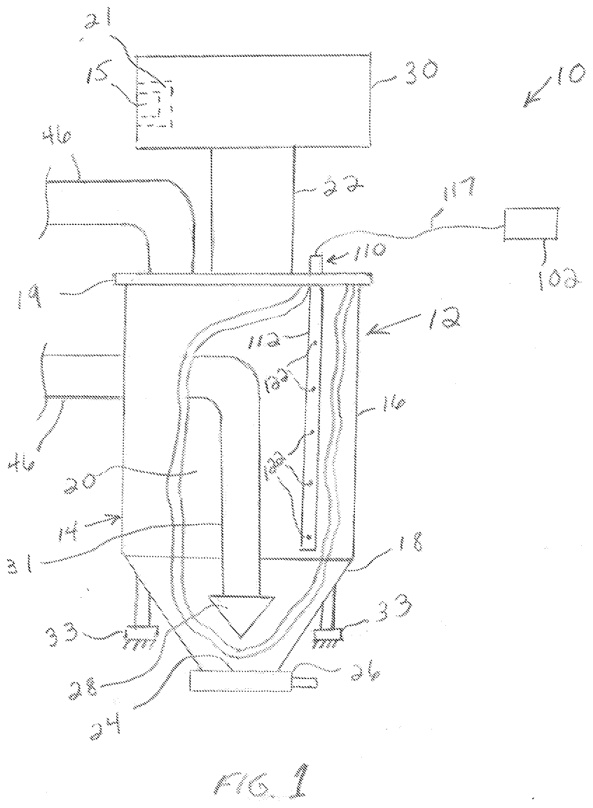

FIG. 1 depicts a system 10 for drying a granular material. The system 10 can be used to remove moisture from, for example, granulates of thermoplastic resin used in injection molding machines to manufacture plastic products. This particular application is disclosed for illustrative purposes only. The system 10, and alternative embodiments thereof, can be used to dry other types of granular materials including, for example, agricultural products such as grains. Also, the term “granular material,” as used herein, is intended to encompass powdered materials including, without limitation, powered materials used in the pharmaceutical industry.

The system 10 includes a drying hopper 12. The drying hopper 12 is configured to hold the granular material, e.g., the resin granulates, in an interior volume 20 of the drying hopper 12, and to direct dry, heated process air over the resin granulates to remove moisture from the resin granulates. (The resin granulates are not shown in the figures, for clarity of illustration.)

The system 10 also includes a sensor array, in the form of a probe 110, that provides measurements of the temperature of the resin granulates, the dew point of the process air, and/or the moisture content of the resin granulates, at various vertical positions within the interior volume 20 of the drying hopper 12, so that the moisture content of the resin granulates within the interior volume 20 can be determined either indirectly from the temperature of the resin granulates and the dew point of the process air, or directly from the granular moisture sensors. After being dried in the drying hopper 12, the resin granulates can be transferred to a process machine, such an injection molding machine (not shown), that processes the granulates into plastic products.

The system 10 also includes a vacuum receiver 30 mounted above the drying hopper 12. The receiver 30 is depicted FIG. 1. The vacuum receiver 30 receives the resin granulates from a storage vessel (not shown) such as a Gaylord box, a container, a silo, a railcar, an octobin, etc. The receiver 30 holds the resin granulates until the drying hopper 12 requires the addition of resin granulates during the initial loading process, and during the drying cycle when the resin granulates within the drying hopper 12 need to be replenished as dried resin granulates are discharged from the drying hopper 12. The use of the system 10 in conjunction with the receiver 30 is disclosed for illustrative purposes only. The system 10 can be loaded directly from the storage vessel using a vacuum loader or other methodology.

The system 10 further includes a moisture sensor 15. The moisture sensor 15 is mounted in a sampling chamber 21 inside the receiver 30, and is communicatively coupled to a controller 102 of the system 10. The moisture sensor 15 and the sampling chamber 21 are depicted in phantom in FIG. 1. The moisture sensor 15 measures the moisture content of the resin granulates entering the drying hopper 12. The moisture sensor 15 can be positioned at other locations upstream of the drying hopper 12, such as in or near the storage vessel, in alternative embodiments.

As discussed below, the controller 102 can be configured to modify the drying time, or residence time, of the resin granulates based on the initial moisture level as measured by the moisture sensor 15. More specifically, the controller 102 can be configured to increase the drying time from the manufacturer's recommended drying time if the as-measured moisture content is above a predetermined baseline level. Conversely, the controller 102 can be configured to decrease the drying time from the manufacturer's recommended drying time if the as-measured moisture content is below the baseline level. Alternative embodiments of the system 10 can be configured without the moisture sensor 15. In such alternative embodiments, the controller 102 will not perform the noted adjustment of the drying time based on the moisture content of the resin granulates entering the receiver 12.

The drying hopper 12 is positioned on, and is supported by a fixed support structure (not shown). The drying hopper 12 can be positioned on a mobile trolley in alternative embodiments. The drying hopper 12 is positioned over, or in close proximity to, the process machine, e.g., the injection molding machine, and supplies the resin granulates to the process machine on a selective basis.

Referring to FIG. 1, the drying hopper 12 comprises a body 14 having a cylindrical upper section 16, and a cone-shaped lower section 18 connected to the upper section 16. The drying hopper 12 also includes a lid or cover 19. The cover 19, and the upper and lower sections 16, 18 of the body 14 define the interior volume 20 of the drying hopper 12. The resin granulates reside in the interior volume 20 during the drying process. The drying hopper 12 also includes a feed mouth 22 mounted on the cover 19, and an output mouth 24 located at the bottom of the lower section 18. The resin granulates enter the interior volume 20 of the drying hopper 12 by way of the feed mouth 22, and exit the drying hopper 12 at the conclusion of the drying process by way of the output mouth 24.

The drying hopper 12 also may include a discharge valve 26 located proximate the output mouth 22. The discharge valve 26 can be, for example, an electrically-actuated gate valve that moves between a closed position and an open position. When in the closed position, the discharge valve 26 covers the bottom of the output mouth 24, thereby preventing the resin granulates in the interior volume 20 from exiting the drying hopper 12. When in the open position, the discharge valve 26 allows the dried resin granulates to exit the drying hopper 12 by way of the output mouth 24. The resin granulates thus travel from the top to the bottom of the drying hopper 12 during the drying cycle. The dried resin granulates exiting the drying hopper 12 can drop, or be conveyed into the process machine. In alternative embodiments, a vacuum conveying control can be used in lieu of the discharge valve 26.

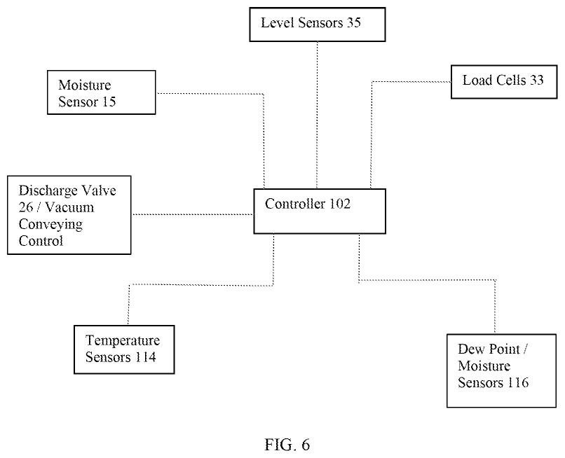

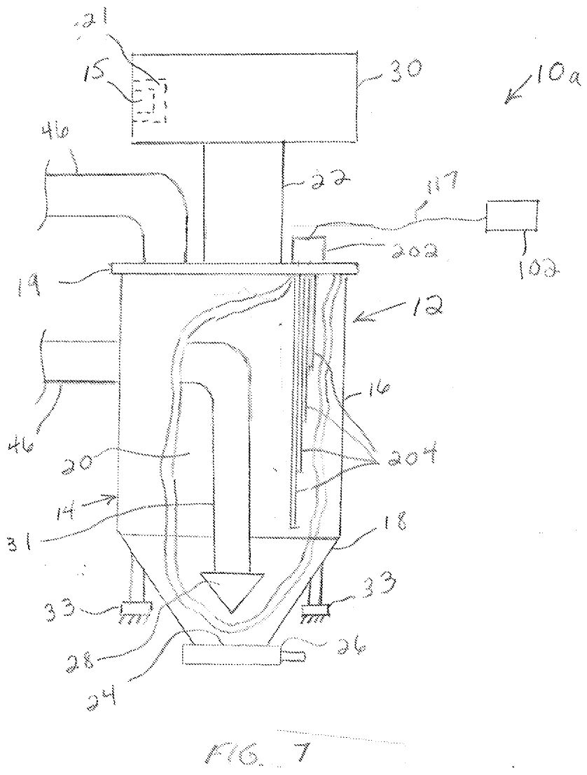

The discharge valve 26 (or vacuum conveying control) is communicatively coupled to a controller 102 of the system 10, as shown in FIG. 6. The controller 102 controls the discharge of the resin granulates from the drying hopper 12. In particular, the controller 102 is configured to generate inputs that cause the discharge valve 26 to open and close (or the vacuum conveying control to turn on and off) in response to user inputs, and when the controller 102 automatically determines that the resin granulates in the lower portion of the interior volume 20 have been subjected the drying process for the desired residence time and/or have reached a desired moisture content.

The drying hopper 12 also includes a diffuser 28, visible in FIG. 1. The diffuser 28 is suspended within the interior volume 20, proximate the bottom of the lower section 18 of the body 14, by an air/gas delivery duct 31. The air/gas delivery duct 31 directs heated and dry, e.g., typically −40° F. dewpoint, process air to the diffuser 28. The diffuser 28 directs the process air outward, in a 360-degree pattern, so that the process air is distributed in a substantially symmetric pattern around the diffuser 28. The process air rises evenly through the interior volume 20, and passes over the resin granulates residing in the interior volume 20. Upon contacting the resin granulates, the process air removes moisture from the resin granulates. The process air eventually reaches the upper end of the interior volume 20, where the process air, now laden with moisture released from the resin granulates, exits the drying hopper 12 by way of a return duct 46.

The rate at which moisture removed from the resin granulates within the drying hopper 12 is dependent upon the operating parameters of the drying hopper 12, e.g., the dew point, volumetric flow rate, and temperature of the process air supplied to the drying hopper 12 via the air/gas delivery duct 31; and the residence time of the resin granulates within the drying hopper 12.

The drying hopper 12 also can include a weight sensing device in the form of, for example, one or more load cells 33 mounted between the body 14 and the support structure of the drying hopper 12. The load cells 33 are depicted in FIGS. 1 and 6. The load cells 33 are communicatively coupled to the controller 102, and generate outputs relating to the combined weight of the drying hopper 12 and its contents, i.e., the resin granulates residing within the drying hopper 12. The controller 102 is configured to calculate the combined weight of the drying hopper 12 and its contents based on the outputs of the load cells 33, and predetermined calibration data stored in the controller 102. The controller 102 can calculate the total weight of the resin granulates residing in the drying hopper 12 based on the combined weight of the drying hopper 12 and its contents, and the empty weight of the drying hopper 12. Alternative embodiments of the system 10 can be configured without the load cells 33.

The drying hopper 12 also includes one or more level sensors 35 mounted within the interior volume 20 of the body 14, or at other suitable locations on or proximate the body 14. The level sensors 35 are depicted in FIG. 6 (the level sensors are not depicted in FIG. 1, for clarity of illustration). The level sensors 35 can be, for example, level switches. The level sensors 35 are communicatively coupled to the controller 102, and generate outputs indicating the level of the resin granulates within the interior volume 20. Alternative embodiments of the drying hopper 12 can be configured without the level sensors 35. For example, alternative embodiments can be equipped with a sight gauge in lieu of the level sensors 35.

The controller 102 comprises a processor, such as a microprocessor; an internal bus; a memory communicatively coupled to the processor via the bus; computer-executable instructions stored in the memory; and an input-output interface communicatively coupled to the internal bus. The controller 102 can have other configurations in alternative embodiments. Also, the controller 102 can include additional components, a description of which is not necessary to an understanding of the disclosed technology.

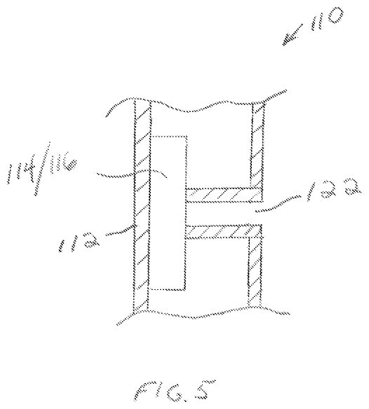

Referring to FIGS. 1-5, the probe 110 comprises a body 112, a first plurality of sensors 114, and a second plurality of sensors 116 (as noted below, alternative embodiments of the probe 110 can include as few one sensor 114 and as few as one sensor 116). The sensors 114, 116 are housed withing the body 112. The probe 110 is configured to be disposed within the interior volume 20 of the drying hopper 12. For example, the probe 110 can be suspended from the cover 19 of the drying hopper 12 as depicted in FIG. 1. In alterative embodiments, the probe 110 can be suspended from the upper section 16 of the body 14 of the drying hopper 12. In other alterative embodiments, the probe 110 can be supported from below by the lower section 18 of the body 14.

The sensors 114 are temperature sensors. In some embodiments, the sensors 116 can be′ dew point sensors. In such embodiments, the probe 110 is configured to measure the temperature of the resin granulates and the dew point of the process air at various vertical locations within the interior volume 20, and the moisture content of the resin granulates is determined indirectly, based on a predetermined correlation between the measured temperature and dew point of the process air.

In other embodiments, the sensors 116 can be moisture sensors that directly measure the moisture content of the resin granulates.

The sensors 114 and the sensors 116 can be positioned in conveniently-spaced locations along the length of the probe 110 as can be seen in FIG. 4, so that the moisture content of the resin granulates can be determined at various vertical locations within the interior volume 20. For example, the probe 110 can be equipped with four of each type of sensor 114, 116. Each sensor 114 can be spaced from its adjacent sensor(s) 114 by about 12 inches (about 30 cm). Each sensor 116 likewise can be spaced from its adjacent sensor(s) 116 by about 12 inches (about 30 cm). The above values for the number and spacing of the sensors 114, 116 are presented for illustrative purpose only, and can vary in alternative embodiments. The optimal number and spacing of the sensors 114, 116 are application-dependent, and can vary with factors such as the geometry of the drying hopper 12, the targeted granulate moisture profile within the drying hopper 12, etc. Alternative embodiments of the probe 110 can be equipped with less, or more than four sensors 114, and with less, or more than four sensors 114. For example, one possible alternative embodiment of the probe 110 can include as few as one sensor 114 and one sensor 116. Also, spacing between adjacent sensors 114 can be non-uniform, and the spacing between adjacent sensors 116 can be non-uniform in alternative embodiments. Also, in embodiments where the sensors 116 are moisture sensors, the probe 10 optionally can be configured without the sensors 114. In other alternative embodiments, the probe 110 can include both dew point sensors and granular moisture sensors, i.e., the probe 110 can include a third set of sensors so that the probe can directly measure the dew point of the process air, and the temperature and moisture content of the resin granulates.

As shown in FIG. 5, each sensor 114 can be co-located with an associated sensor 116 within a common housing with within the body 112, and the pair of sensors 114, 116 can be in fluid communication with the interior volume 20 of the drying hopper 12 by way of an associated common passage 122. In embodiments where the sensors 116 are moisture sensors, the passages 122 also can act as sampling chambers for the sensors 116. The sensors 114, 116 can be housed separately within the body 112 in alternative embodiments of the probe 110.

The lowermost pair of sensors 114, 116 can be located, for example, at a height, or vertical position, that corresponds approximately with the vertical position of the interface between the upper section 16 and the lower section 18 of the drying hopper 12, as shown in FIG. 1. The uppermost pair of sensors 114, 116 can be located at a height that is far enough below the top of the drying hopper 12 to ensure that the uppermost sensors 114, 116 are immersed in the resin granulates throughout the normal range of operating condition of the drying hopper 12.

Each of the sensors 114 and sensors 116 are communicatively coupled to the controller 102 by a respective wired connection 117. The sensors 114, 116 can be communicatively coupled to the controller 102 by a suitable wireless connection in alternative embodiments.

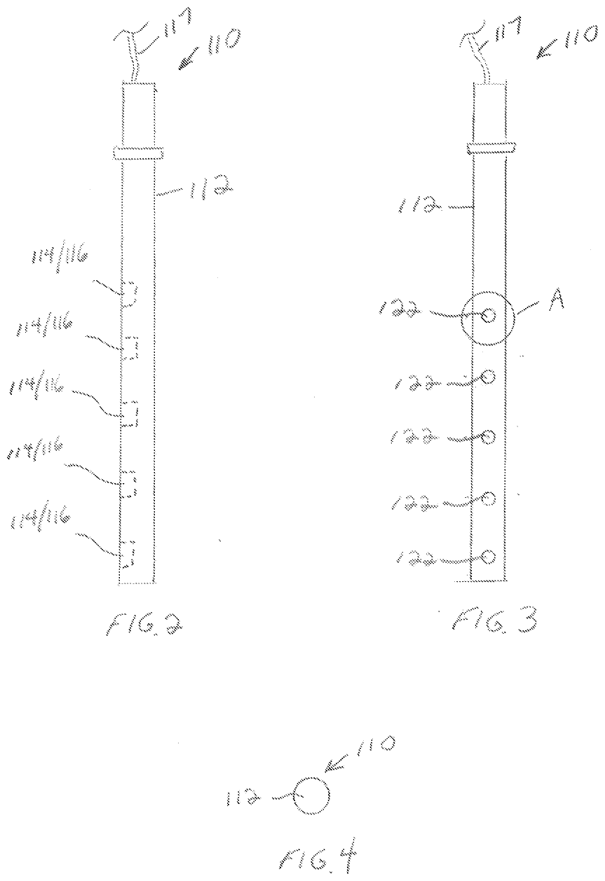

The body 112 can be formed from a material suitable for use in the high temperatures that occur within the interior volume 20 of the drying hopper 12. For example, the body 112 can be formed from aluminum or stainless steel. The body 112 can be formed from other materials in the alternative. The body 112 can have a cylindrical configuration as shown in FIGS. 2-4. The body 112 can have other configurations in alternative embodiments.

In embodiments where the sensors are dew-point sensors, the sensors 116 can be configured as polymer-type dew point sensors. Other types of dew point sensors, such as metal-oxide sensors, quartz-crystal microbalance (QCM) sensors, chilled mirror sensors, etc., can be used in the alternative.

In embodiments where the sensors 116 are moisture sensors, the sensors 116 can be configured as capacitive moisture sensors. Other types of moisture sensors, such as microwave-based sensors, non-dispersive infrared sensors, etc., can be used in the alternative.

The sensors 114 can be configured as resistance temperature detectors (RTDs). The sensors 114 can be configured as other types of temperature sensors, such as thermistors, thermocouples, infrared sensors, IC temperature sensors, negative temperature coefficient (NTC) sensors, etc., in the alternative.

The probe 110 is immersed in the resin granulates residing in the interior volume 20 during the drying operation. The sensors 114 thus measure the approximate temperature of the resin granulates within the interior-volume 20 at the different locations along the length of the probe 110. In embodiments where the sensors 116 are dew point sensors, the sensors 116 measure the inter-granular dew point of the air within the interior-volume 20, i.e., the sensors 116 measure the dew point of the air in the interstices between the resin granulates at the different locations along the length of the probe 110. In embodiments where the sensors 116 are granular moisture, the sensors 116 directly measure the moisture content of the resin granulates at the different locations along the length of the probe 110.

Alternative embodiments of the probe 110 can be configured as two separate probes, with one probe housing the sensors 114 and the other probe housing the sensors 116. In other alternative embodiments, each of the sensors 114, 116 can be mounted individually on an interior or exterior surface or surfaces of the drying hopper 12, without being mounted on or in a separate housing or mounting structure such as body 112. In other alternative embodiments, all of the sensors 114, 116 can be located within a common housing that is located outside of the interior volume 20 of the drying hopper 12. For example, FIG. 7 depicts an alternative embodiment in the form of a system 10a in which the sensors 114, 116 are located within a housing 202 configured for mounting outside of the interior volume 20 of the drying hopper 12. The system 10a otherwise can be substantially the same as the system 10. The sensors 114, 116 are in fluid communication with the interior volume 20 by way of conduits 204. The conduits 204 can be tubes, pipes, and other structures that can place the sensors 114, 116 in fluid communication with the interior volumes 20. Each conduit 204 is associated with one pair of sensors 114, 116. The conduits 204 have different lengths, so that the respective ends or entrances to the conduits 204 are located at the various levels within the interior volume 20 at which the temperature and dew point/granular-moisture measurements are to be acquired.

In embodiments where the sensors 116 are dew point sensors, the controller 102 can be configured to indirectly determine the moisture content of the resin granulates at the various sensing levels within the interior volume 20, based on the temperature and dew-point measurements from the respective temperature sensors 114 and dew-point sensors 116. In particular, the controller 102 can be programmed with a predetermined correlation between the moisture content of the resin granulates, and the temperature of the resin granulates and the interstitial dew point of the air within the interior volume 20. The controller 102 can be configured to determine the moisture content of the resin granulates based on this correlation, and the data acquired from the sensors 114, 116.

In embodiments where the sensors 116 are moisture sensors, the controller 102 can be configured to directly determine the moisture content of the resin granulates at the various sensing levels within the interior volume 20, based on the granular moisture measurements provided by the sensors 116.

The controller 102 can be configured to adjust one or more of the operating parameters of the drying hopper 12 to maintain a desired, or targeted, vertical profile in the granulate moisture content, based on the direct or indirect moisture-content measurements provided by the probe 110.

The targeted vertical profile for the granulate moisture content can be determined before the drying operation. In particular, a curve of the targeted moisture content vs. drying time can be developed for the drying process based on manufacturer-supplied data regarding the drying characteristics of the granulates (including the recommended drying temperature); the known drying characteristics of the drying hopper (including the recommended dew point and flow rate of the process air provided by the hopper manufacturer); and the residence time adjusted for the initial moisture content of the resin granulates.

An individual targeted drying curve can be generated for each level within the interior volume 20 at which the sensors 114, 116 are located. The individual drying curves collectively define the targeted profile of the moisture content of the resin granulates as a function of the vertical position of the resin granulates within the interior volume 20, and the time over which the resin granulates have been subjected to the drying process.

During operation, the drying hopper 12 initially can be filled with the resin granulates to a level based on the manufacturer's suggested residence time for the particular type of resin granulates being dried, the throughput of the drying hopper 12, and the bulk density of the granulates. The moisture content of the resin granulates being loaded in the drying hopper 12 can be measured by the moisture sensor 15 positioned in the receiver 30. The controller 102 can modify the desired residence time of the resin granulates based on the moisture level as measured by the moisture sensor 15. More specifically, the controller 102 can be configured to increase the residence time from the manufacturer's recommendation if the as-measured moisture content is above a predetermined baseline level. Conversely, the controller 102 can be configured to decrease the residence time from the manufacturer's recommendation if the as-measured moisture content is below the baseline level.

The temperature, dew point, and flow rate of the process air initially can be set to the predetermined levels used to formulate the targeted drying profile as discussed above. Once the flow of process air to the interior volume 20 of the drying hopper has commenced, the controller 102 compares the actual vertical profile of the granulate moisture content, as determined directly or indirectly from the sensor data acquired at the various vertical positions within the drying hopper 12, to the predetermined targeted profile for a given time in the drying process.

If the average actual moisture content profile differs by more than a predetermined amount from the targeted moisture content profile, the controller 102 can adjust one or more of the operating parameters of the drying hopper 12 to maintain the targeted profile in the actual granulate moisture content.

If necessary, the actual drying profile can be adjusted, for example, by varying the dew point of the process air being supplied to the hopper 20. Specifically, if the actual moisture content of the resin granulates is greater than targeted at a given time in the drying process, i.e., if the resin granulates are drying more slowly than expected, the dew point of the process air can be lowered to increase the rate at which moisture is being removed from the resin granulates. Conversely, if the actual moisture content of the resin granulates less than targeted at a given time in the drying process, i.e., if the resin granulates are drying more quickly than expected, the dew point of the process air can be raised to decrease the rate at which moisture is being removed from the resin granulates.

Alternatively, or in addition, the actual drying profile can be adjusted by varying the flow rate and/or the temperature of the process air as needed to increase or decrease the rate at which moisture is being removed from the resin granulates. If the targeted drying profile cannot be achieved by varying the above-noted operating parameters, the residence time of the resin granulates can be increased or decreased so that the resin granulates have the targeted moisture content upon exiting the drying hopper 20.

The controller 102 can be configured to determine the actual moisture content of the resin granulates on a real-time, continuous basis, using the above-noted direct or indirect measurement techniques. Adjustments in the operating parameters of the drying hopper 12, if needed, can be made at intervals frequent enough to help ensure that there is sufficient time for the adjustments to have the desired corrective effect by the time the resin granulates are discharged from the drying hopper 12. The system 10 optionally can be provided with an alarm that is activated by the controller 102 if the deviation between the actual and targeted moisture-content profiles exceeds a predetermined level.

Maintaining a desired vertical profile in the granulate moisture content within the interior volume 20 of the drying hopper 12 can help ensure that the resin granulates are properly dried upon leaving the drying hopper 12. In particular, the sensors 114, 116 are located far enough from the exit of the drying hopper 12 to permit the operating parameters of the drying hopper 12 to be adjusted while there is still an opportunity to effect a change in the moisture content of the resin granulates by the time the resin granulates reach the exit of the drying hopper 12.

Thus, because the data provided by the sensors 114, 116 provide a real-time indication of the actual moisture content of the resin granulates inside of the drying hopper 12, i.e., downstream of the entrance to the interior volume 20 and upstream of the exit of the drying hopper 12, the system 10 can automatically regulate the performance of the drying hopper 12 to guarantee a desired result, i.e., a desired moisture level in the granulates leaving the drying hopper 12.

By contrast, measuring the granulate moisture content at the exit of the drying hopper 12 can result in over-dried or under-dried resin granulates, because the drying process for the resin granulates exiting the drying hopper 12 already has been completed and, therefore, no corrective action can be taken for those resin granulates. Over-dried granulates may need to be discarded, or ground into smaller particles and combined with virgin resin. At a minimum, over-drying of the resin granulates results in excessive energy usage. Under-dried granulates typically need to be subjected to another drying cycle to bring the moisture content within specification. If a molded product part or product was made from the under-dried granulates, the part or product typically needs to be ground to prevent a potentially defective part or product from reaching the end user. Thus, the ability to monitor the drying process within the drying hopper 12 on a real-time basis using a sensor array such as the probe 110, and the resulting ability of the system 10 to adjust the operating parameters prospectively, before the resin granulates reach the exit of the drying hopper 12, can help avoid over-dried and under-dried resin granulates, and the waste, productions inefficiencies, and product defects associated with over-dried and under-dried resin granulates.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

We claim:

1. A process for drying a granular material, comprising:
providing a drying hopper configured to direct air over the granular material while the granular material resides within an interior volume of the drying hopper;
determining an actual moisture content of the granular material within the interior volume; and
altering one or more parameters of the drying process based on the actual moisture content of the granular material within the interior volume.

2. The process of claim 1, wherein altering one or more parameters of the drying process based on the actual moisture content of the granular material within the interior volume of the drying hopper comprises altering a property of the air.

3. The process of claim 2, wherein altering a property of the air comprises altering a temperature, a volumetric flow rate, and/or a dew point of the air based on the actual moisture content of the granular material within the interior volume.

4. The process of claim 1, wherein altering one or more parameters of the drying process based on the actual moisture content of the granular material within the interior volume comprises altering a residence time of the granular material within the interior volume.

5. The process of claim 1, wherein determining an actual moisture content of the granular material within the interior volume of the drying hopper comprises determining an actual moisture content of the granular material at a plurality of vertical locations within the interior volume.

6. The process of claim 1, further comprising providing a sensor array comprising at least one sensor configured to provide information relating to the actual moisture content of the granular material within the interior volume, wherein determining an actual moisture content of the granular material within the interior volume comprises determining the actual moisture content of the granular material within the interior volume based on the information relating to the actual moisture content of the granular material within the interior volume.

7. The process of claim 6, wherein providing a sensor array comprising at least one sensor configured to provide information relating to the actual moisture content of the granular material within the interior volume comprises:
providing at least one temperature sensor configured to measure a temperature of the granular material; and
providing at least one dew-point sensor configured to measure a dew point of the air within interior volume.

8. The process of claim 7, wherein:
providing at least one temperature sensor configured to measure a temperature of the granular material comprises providing a plurality of the temperature sensors configured to measure the temperature of the granular material at a plurality of vertical positions within the interior volume; and
providing at least one dew-point sensor configured to measure a dew point of the air with interior volume comprises providing a plurality of the dew-point sensors configured to measure the dew-point of the air within the interior volume at a plurality of vertical positions within the interior volume.

9. The process of claim 8, further comprising immersing at least a portion of the sensor array in the granular material within the interior volume.

10. The process of claim 6, wherein providing at least one sensor configured to provide information relating to the actual moisture content of the granular material within the interior volume comprises providing at least one moisture sensor configured to directly measure the actual moisture content of the granular material.

11. The process of claim 10, wherein providing at least one moisture sensor configured to directly measure the actual moisture content of the granular comprises providing a plurality of the moisture sensors configured to directly measure the actual moisture content of the granular material at a plurality of vertical positions within the interior volume.

12. The process of claim 11, further comprising immersing at least a portion of the sensor array in the granular material within the interior volume.

13. The process of claim 1, wherein altering a parameter of the drying process based on the actual moisture content of the granular material within the interior volume of the drying hopper comprises altering the parameter of the drying process based on a difference between the actual moisture content of the granular material within the interior volume and a targeted moisture content of the granular material.

14. The process of claim 13, wherein:
determining an actual moisture content of the granular material within the interior volume of the drying hopper comprises determining an actual moisture content of the granular material at a plurality of vertical locations within the interior volume; and
altering a parameter of the drying process based on a difference between the actual moisture content of the granular material within the interior volume and a targeted moisture content of the granular material comprises altering the parameter of the drying process based on a difference between a vertical profile of the actual moisture content of the granular material within the interior volume and a vertical profile the targeted moisture content of the granular material.

15. A system for drying a granular material, comprising:
a drying hopper defining an interior volume configured to hold the granular material, an air inlet configured to facilitate the passage of air into the interior volume, an entrance opening configured to facilitate entry of the granulate material into the interior volume, and an exit opening configured to facilitate exit of the granulate material from the interior volume;
a sensor array comprising one or more sensors configured to sense at least one parameter within the interior volume indicative of a moisture content of the granular material within the interior volume; and
a controller communicatively coupled to the one or more sensors and configured to determine the moisture content of the granular material within the interior volume based on the at least one parameter within the interior volume indicative of a moisture content of the granular material within the interior volume.

16. The system of claim 15, wherein the at least one parameter within the interior volume indicative of a moisture content of the granular material within the interior volume is a temperature of the granular material and a dew-point of the air within the interior volume.

17. The system of claim 15, wherein the at least one parameter within the interior volume indicative of a moisture content of the granular material within the interior volume is an actual moisture of the granular material.

18. The system of claim 15, wherein the sensor array comprises a probe configured to be immersed in the granular material, the probe comprising a body, and the one or more sensors housed within the body.

19. The system of claim 15, wherein:
the sensor array comprises a plurality of the sensors; and
the one or more sensors are positioned at a plurality of vertical locations within the interior volume.

20. The system of claim 16, wherein:
at least one of the one or more sensors comprises a temperature sensor configured to measure a temperature of the granular material; and
at least one of the sensors comprises a dew point sensor configured to measure a dew-point of the air with interior volume.

21. The system of claim 17, wherein at least one of the one or more sensors comprises a moisture sensor configured to directly measure the moisture content of the granular material.

22. The system of claim 15, wherein the controller is further configured to regulate at least one operating parameter of the drying hopper based on the at least one parameter within the interior volume.

23. The system of claim 22, wherein the controller is further configured to regulate at least one of a volumetric flow rate of the air, a temperature of the air, and a dew point of the air based on the at least on parameter sensed within the interior volume.

24. The system of claim 22, wherein the controller is further configured to:
compare the actual moisture content of the granular material within the interior volume to a targeted value for the moisture content of the granular material within the interior volume; and
regulate the at least one operating parameter based on the comparison of the actual moisture content of the granular material within the interior volume to the targeted value for the moisture content of the granular material within the interior volume.

25. The system of claim 24, wherein:
the sensor array comprises a plurality of the sensors configured to sense the at least one parameter within the interior volume;
the plurality of sensors are positioned at a plurality of vertical locations within the interior volume; and
the controller is further configured to regulate the at least one operating parameter based on a difference between a vertical profile of the actual moisture content of the granular material within the interior volume and a vertical profile the targeted moisture content of the granular material within the interior volume.

26. The system of claim 15, wherein the sensor array further comprises:
a housing configured to be mounted at least in part outside of the drying hopper, the one or more sensors being disposed within the housing; and
one or more conduits in fluid communication with the one or more sensors and the interior volume of the drying hopper.

27. A sensor array configured for use with a drying hopper for drying a granular material, the hopper defining an interior volume configured to hold the granulate material, an air inlet configured to facilitate the passage of air into the interior volume, an entrance opening configured to facilitate entry of the granulate material into the interior volume; and an exit opening configured to facilitate exit of the granular material from the interior volume; the sensor array comprising:
one or more sensors configured to sense at least one parameter within the interior volume of the drying hopper indicative of a moisture content of the granular material within the interior volume.

28. The sensor array of claim 27, further comprising a probe configured to be immersed in the granular material and comprising a body, and the one or more sensors housed within the body.

29. The sensor array of claim 28, wherein the one or more sensors comprise a plurality of the sensors; and
the probe is further configured so that the plurality of sensors are positioned at a plurality of vertical locations within the interior the volume when the probe is installed on the drying hopper.

30. The sensor array of claim 27, wherein the sensor array further comprises:
a housing configured to be mounted at least in part outside of the drying hopper, the one or more sensors being disposed within the housing; and
one or more conduits configured to communicate fluidly with the one or more sensors and the interior volume of the drying hopper.

31. The sensor array of claim 30, wherein:
the one or more sensors comprise a plurality of the sensors;
the one or more conduits comprise a plurality of the conduits; and
the conduits are configured so that respective entrances of the conduits are positioned at a plurality of vertical locations within the interior the volume when the sensor array is installed on the drying hopper.

32. The sensor array of claim 27, wherein the one or more sensors comprise a temperature sensor configured to measure a temperature of the granular material, and a dew point sensor configured to measure a dew point of the air with interior volume.

33. The sensor array of claim 27, wherein the one or more sensors comprise a moisture sensor configured to directly measure a temperature of the granular material.

34. The sensor array of claim 27, further comprising a controller communicatively coupled to the one or more sensors, wherein the one or more sensors are further configured to generate an output that, when received by the controller, causes the controller to determine the moisture content of the granular material within the interior volume based on the output.

35. The sensor array of claim 34, wherein the controller is further configured to regulate an operating parameter of the drying hopper based on the moisture content of the granular material within the interior volume.

36. The sensor array of claim 35, wherein the controller is further configured to:
compare the moisture content of the granular material within the interior volume to a targeted value for the moisture content of the granular material within the interior volume; and
regulate the at least one operating parameter based on the comparison of the moisture content of the granular material to the targeted value for the moisture content of the granular material.
